(19) United States
(12) Patent Application Publication
(10) Pub. No.: US 2024/0006700 A1
(43) Pub. Date: Jan. 4, 2024

(54) BATTERY CELL ADAPTOR

(71) Applicant: MILWAUKEE ELECTRIC TOOL CORPORATION, Brookfield, WI (US)

(72) Inventors: Kyle C. Fassbender, Brookfield, WI (US); Anthony M. Miosi, Brookfield, WI (US); Samuel Sheeks, Germantown, WI (US); Matthew R. Polakowski, Greenfield, WI (US); Scott Anderson, Racine, WI (US); Derek J. Schwab, Glendale, WI (US); Ryan R. Kohlmeyer, Brookfield, WI (US)

(21) Appl. No.: 18/342,945

(22) Filed: Jun. 28, 2023

Related U.S. Application Data
(60) Provisional application No. 63/356,854, filed on Jun. 29, 2022.

(51) Int. Cl. H01M 50/247; H01M 10/42; H01M 50/262

(52) U.S. Cl. CPC H01M 50/247; H01M 10/425; H01M 50/262; H01R 13/6205

(57) ABSTRACT

A power tool system includes first and second power tools, each having a mechanical connector and an electrical connector. At least one of the connectors of the second power tool is dissimilar from the connectors of the first power tool. The power tool system further includes a battery housing defining a cavity therein, a battery cell positioned within the cavity of the battery housing, a mechanical connector configured to mechanically couple with the mechanical connector of the first power tool, an electrical connector configured to electrically couple with the electrical connector of the first power tool, and an adaptor configured to removably engage a connector of the battery such that the battery is configured to couple to the second power tool when the adaptor is coupled to the battery and is configured to couple to the first power tool when the adaptor is removed from the battery.

### BACKGROUND

Battery technology allows power tools and other portable devices such as lighting equipment, cooling devices, yard tools, and sound systems to be used in a cordless manner. Different batteries can implement different form factors such as a cylindrical form factor or a pouch form factor, each having different advantages in size, shape, packing density, power density, ease of manufacture, and/or cost of manufacture.

### SUMMARY

The present disclosure relates to a power tool system. The power tool system includes a first power tool having a mechanical connector and an electrical connector and a second power tool having a mechanical connector and an electrical connector. At least one of the mechanical or the electrical connector of the second power tool is dissimilar from the mechanical or the electrical connector of the first power tool. The power tool system further includes a battery housing defining a cavity therein, the battery housing at least partially defined by an upper housing portion, a battery cell positioned within the cavity of the battery housing, a mechanical connector physically coupled to the upper housing portion and configured to mechanically couple with the mechanical connector of the first power tool, an electrical connector electrically coupled to the battery cell and configured to electrically couple with the electrical connector of the first power tool, and an adaptor configured to removably engage the mechanical connector of the battery and/or the electrical connector of the battery such that the battery is configured to mechanically and electrically couple to the second power tool when the adaptor is coupled to the battery and is configured to mechanically and electrically couple to the first power tool when the adaptor is removed from the battery.

The present disclosure further relates to a power tool system. The power tool system includes a power tool having a mechanical connector and an electrical connector, a battery housing defining a cavity therein, the battery housing at least partially defined by an upper housing portion, a battery cell positioned within the cavity of the battery housing, a mechanical connector physically coupled to the upper housing portion and configured to mechanically couple with the mechanical connector of the power tool, and an electrical connector electrically coupled to the battery cell and configured to electrically couple with the electrical connector of the power tool. Each of the electrical connector of the battery cell and the electrical connector of the power tool is a magnetic connector such that the electrical connector of the battery cell and the electrical connector of the power tool form a magnetic connection.

The present disclosure further relates to a power tool system. The power tool system includes a first power tool having an electrical connector formed as a magnetic connector, a second power tool having an electrical connector formed as a terminal block, a battery housing defining a cavity therein, the battery housing at least partially defined by an upper housing portion, a battery cell positioned within the cavity of the battery housing, a first electrical connector physically coupled to the upper housing portion and formed as a magnetic connector configured to electrically couple the first power tool with the battery cell, and a second electrical connector physically coupled to the upper housing portion and formed as a terminal block configured to electrically couple the second power tool with the battery cell.

### BRIEF DESCRIPTION OF THE DRAWINGS

FIG. 1 is a perspective view of a battery cell adaptor according to one embodiment.

FIG. 2A is a schematic representation of a terminal block and separate adaptor.

FIG. 2B is a schematic representation of the terminal block and adaptor of FIG. 2A, in an assembled state.

FIG. 3 is a perspective view of a battery cell adaptor according to another embodiment.

FIG. 4 is a schematic representation of a battery, a power tool, and an adaptor positioned therebetween.

FIG. 5A is a perspective view of a battery housing configured to receive a battery cell adaptor according to yet another embodiment.

FIG. 5B is a side view of the battery housing of FIG. 5A coupled to the battery cell adaptor.

FIG. 6A is a perspective view of a battery having a battery cell adaptor according to yet another embodiment mounted thereto.

FIG. 6B is an exploded view of the battery and battery cell adaptor of FIG. 4A.

FIG. 7 is a schematic representation of terminal block according to some embodiments.

FIG. 8 is a schematic representation of a battery-to-power tool attachment arrangement according to an embodiment.

FIG. 9 is a schematic representation of a battery-to-power tool attachment arrangement according to another embodiment.

FIG. 10 is a schematic representation of a battery-to-power tool attachment arrangement according to yet another embodiment.

FIG. 11 is a schematic representation of a battery-to-power tool attachment arrangement according to yet another embodiment.

### DETAILED DESCRIPTION

Before any embodiments are explained in detail, it is to be understood that the disclosure is not limited in its application to the details of construction and the arrangement of components set forth in the following description or illustrated in the following drawings. The disclosure is capable of other embodiments and of being practiced or of being carried out in various ways. Also, it is to be understood that the phraseology and terminology used herein is for the purpose of description and should not be regarded as limiting. The use of “including,” “comprising” or “having” and variations thereof herein is meant to encompass the items listed thereafter and equivalents thereof as well as additional items. The terms “mounted,” “connected” and “coupled” are used broadly and encompass both direct and indirect mounting, connecting and coupling. Further, “connected” and “coupled” are not restricted to physical or mechanical connections or couplings, and can include hydraulic or electrical connections or couplings, whether direct or indirect.

Battery-operated devices such as power tools often utilize rechargeable batteries that are removable, rechargeable, and replaceable. This arrangement allows a first battery (i.e., power storage device, battery pack) to electrically and mechanically couple to the power tool for use while a second battery charges via a separate battery charger such that when the first battery is depleted, the second battery may be electrically and mechanically coupled for use while the first battery is charged via the battery charger. The batteries have electrical connectors that electrically couple to mating connectors of the power tool (and the battery charger) such that the power tool is powered by the coupled battery. Mechanical connectors are implemented on the battery in addition to the electrical connectors to mechanically fasten the battery to mating mechanical fasteners of the power tool (and the battery charger) to hold the battery thereto. By mechanically and electrically coupling the battery to the power tool, the battery is both functional to provide power to the power tool and to remain fixed to the power tool.

Different power tools have different arrangements for electrically and mechanically coupling to batteries that can prohibit certain batteries from coupling to certain power tools. These differences may include, for example, electrical contacts of different lengths, widths, or heights, electrical contacts in different arrangements or locations along the body of the battery, and batteries having different numbers of electrical contacts. Similarly, batteries can include different mechanical interfaces for engaging certain power tools. These mechanical interfaces can also prohibit attachment to other power tools. As such, certain power tools are usable with only certain batteries and certain batteries are usable with only certain power tools based on mechanical and electrical components associated with the battery that are only configured to electrically or mechanically couple to certain power tools.

As shown in the figures, systems are provided for electrically and mechanically coupling a battery to a power tool that has dissimilar electrical and/or mechanical interfaces. In this way, a battery that is typically unable to couple (either mechanically, electrically, or both) to a particular power tool is able to do so via the coupling means described below.

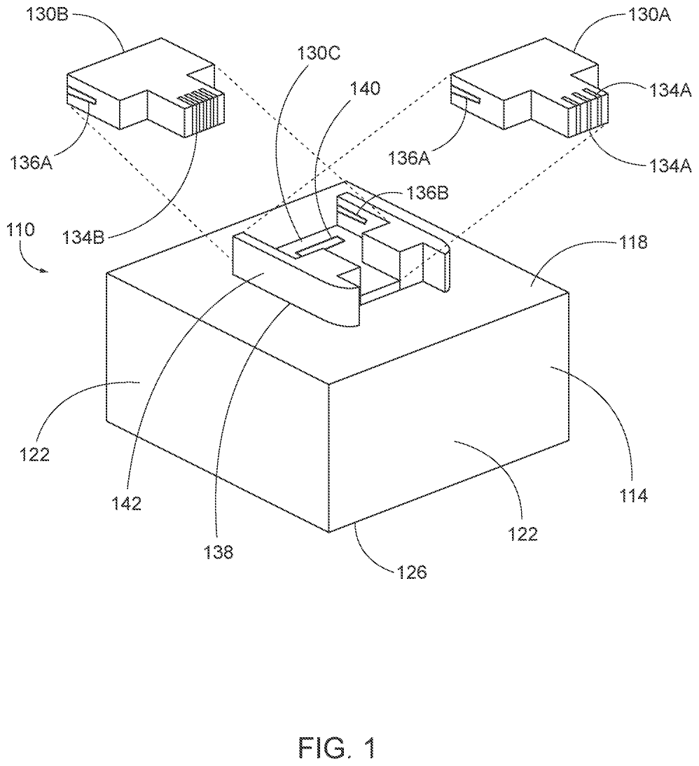

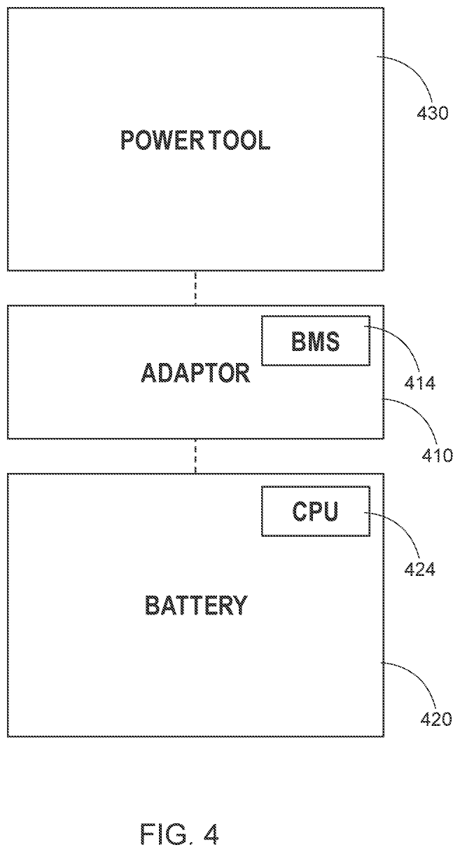

In a first embodiment shown in FIG. 1, a battery 110 includes a battery housing 114 defined by an upper housing portion 118, a plurality of sidewalls 122, and a lower housing portion 126 opposite the upper housing portion 118 and connected to the upper housing portion via the plurality of sidewalls 122. The housing 114 has a cavity that supports one or more battery cells therein. The battery cells may have, for example, a pouch form factor or a cylindrical form factor. A first electrical terminal block 130A having a plurality of contacts 134A is mounted to the upper housing portion 118. While shown mounted centrally on the upper housing portion 118, the specific location can vary. The contacts 134A are mounted within slots parallel to one another for engaging corresponding contacts on any of a first plurality of power tools. The battery housing 114 further includes a mechanical connector 138 extending upward from the upper housing portion 118 and partially surrounding the electrical terminal block 130A. The mechanical connector 138 includes one or more coupling features 142 for mechanically coupling to any one of the first plurality of power tools. Some examples of coupling features 142 include alignment aids such as linear extrusions for engaging mating slots in a power tool or linear slots for engaging mating extrusions on a power tool. Further examples of coupling features include latches, clasps, or catches for locking the battery 110 relative to a mating power tool. A release button (similar to release button 680 shown in FIGS. 4A-4B) may be incorporated into the housing 114 of the battery 110 for releasing and/or unlocking the battery 110 from the mating power tool.

With continued reference to FIG. 1, the terminal block 130A of the battery 110 is removably coupled to the battery housing 114 and is replaceable by another terminal block 130A, the terminal block 130A having the same arrangement of electrical contacts 134A (e.g., if the electrical contacts 134A of the original terminal block 130A are inoperable) or an alternative arrangement of electrical contacts 134B. When replacing the terminal block 130A with a new terminal block 130B having a different arrangement of electrical contacts 134B, the battery 110 is capable of electrically coupling to a second plurality of power tools (separate from the first plurality of power tools) that are configured to engage the same mechanical coupling features 142 (as these remain fixed to the battery housing) but that engage the arrangement of electrical connectors 134B on the new terminal block 130B. In this way, the battery 110 is capable of electrically and mechanically coupling with two different power tools having different configurations of electrical contacts.

The separable terminal block 130A, 130B may be coupled directly or indirectly (i.e., via an intermediate component positioned between the terminal block 130A, 130B and the housing 114 or via connection to the mechanical connector 138) to the upper housing portion 118 of the housing 114. The terminal blocks 130A, 130B are each separately couplable to the housing 114 via a mechanical retention mechanism. In some embodiments, the terminal block 130A, 130B is removably coupled to the housing 114 via fasteners (e.g., screws) that require tools for removal. In other embodiments, a quick-release latch or other tool-free retention mechanism (e.g., slot and mating protrusion) may couple the terminal block 130A, 130B to the housing 114. In the embodiment shown in FIG. 1, the retention mechanism 132 includes similar protrusions 136A on each terminal block 130A, 130B and a mating slot 136B formed on the housing 114. In some embodiments, the housing 114 includes a recess 130C sized to receive the terminal blocks 130A, 130B to assist in the correct placement and orientation of the respective terminal block 130A, 130B relative to the housing 114.

Further, electrical communication between the separable terminal blocks 130A, 130B and the batteries within the housing 114 is accomplished via an electrical interface 140 of the housing 114. The electrical interface 140 provides an electrical connection between the batteries and the electrical contacts 134A, 134B when the respective terminal block 130A, 130B is mechanically coupled to the housing 114.

In operation, coupling the battery 110 when equipped with the first terminal block 130A includes electrically coupling the battery 110 to electrical terminals of the first power tool and mechanically engaging the mechanical connector 138 with a mating mechanical interface of the first power tool. When the battery 110 is mechanically and electrically uncoupled from the first power tool, a user can remove the terminal block 130A from the remainder of the battery 110 and replace it with a different, dissimilar terminal block 130B having a different arrangement, size, and/or number of contacts. After connecting the dissimilar terminal block 130B, the battery 110 can be coupled to a second power tool via the same mechanical connector 138 and via the new electrical connection of the second terminal block 130B. As such, the battery 110 is capable of providing power to different power tools having different electrical connectors.

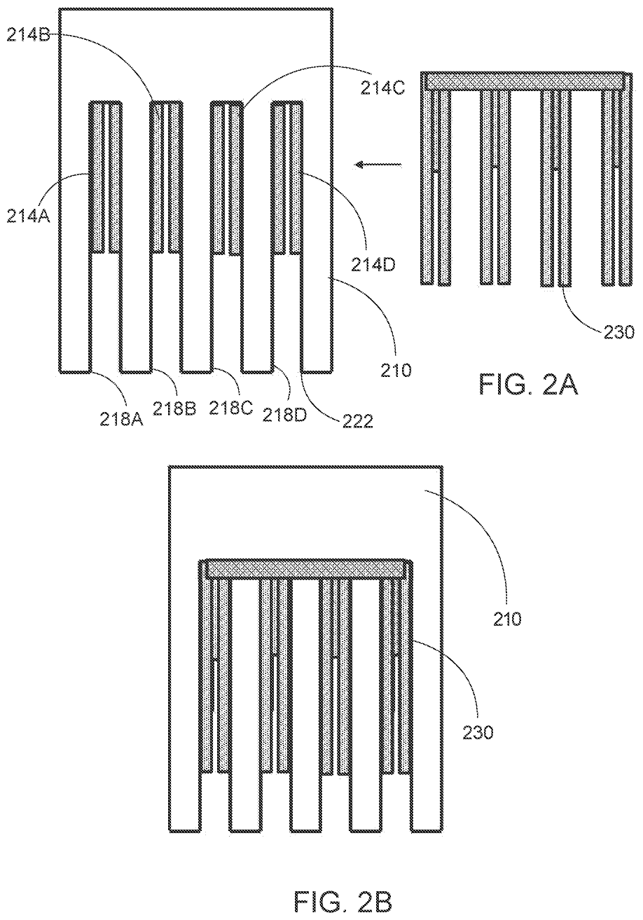

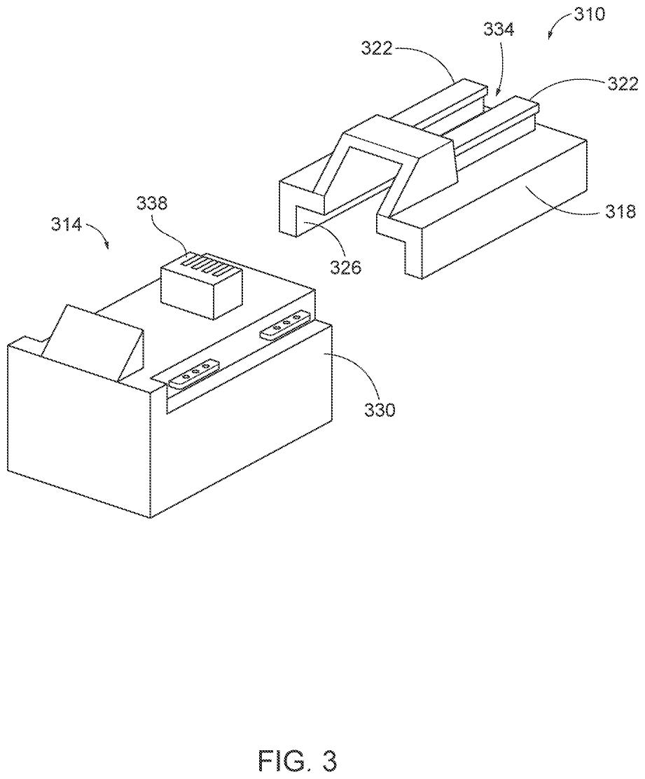

In a second embodiment, as shown in FIGS. 2A-2B, a terminal block 210 is fixed to the remainder of the battery cell (i.e., not removable as in the first embodiment). The terminal block 210 has a plurality of contacts 214A, 214B, 214C, 214D each of which is seated within a respective slot 218A, 218B, 218C, 218D of the terminal block 210. The slots 218A, 218B, 218C, 218D are oriented in a direction aligned with the alignment feature of the mechanical connector (similar to the arrangement shown in FIG. 3) such that a motion (e.g., a sliding motion) that couples the mechanical connector of the battery with the mating mechanical connector of the power tool likewise engages the electrical contacts of the battery with the electrical contacts of the power tool. For some power tools, the electrical connectors 214A, 214B, 214C, 214D may be located at a depth within their respective slots 218A, 218B, 218C, 218D (depth measured relative to the insertion point 222 of the power tool contacts into the slots) that cannot be reached by the contacts of the power tool. Written another way, when successfully mechanically coupling some power tools to the battery by mating the respective mechanical connectors, the electrical contacts of the power tool do not extend far enough into the slots of the terminal block to engage the connectors of the battery. As such, even when mechanically coupled, the battery is not capable of providing power to the power tool. In order to electrically couple to such a power tool, an electrical adaptor 230 is provided between the contacts 214A, 214B, 214C, 214D of the battery and the contacts of the power tool to provide an electrical connection therebetween. The adaptor 230 is made of (either entirely or partially) an electrically conductive material. In some embodiments, the adaptor 230 is inserted into the respective slots 218A, 218B, 218C, 218D of the terminal block to effectively extend the lengths of the contacts 214A, 214B, 214C, 214D of the battery such that they reach the contacts of the power tool when the power tool is mechanically coupled to the battery. In other embodiments, the adaptor mates with the contacts of the power tool to effectively extend the lengths of the contacts of the power tool. FIG. 2A illustrates the terminal block 210 separate from the adaptor 230 and FIG. 2B illustrates the adaptor 230 installed onto the terminal block 210.

In operation, a battery is configured to electrically and mechanically couple with a first power tool by coupling a mechanical connector 214A, 214B, 214C, 214D of the battery with a mechanical connector of the power tool (e.g., sliding the battery into engagement with a slot/protrusion of the power tool). When the battery is mechanically coupled, the contacts of the power tool engage contacts 214A, 214B, 214C, 214D of the battery such that the battery is electrically coupled to the power tool and provides power to the power tool. In switching to a second tool that is not capable of simply engaging the contacts 214A, 214B, 214C, 214D of the battery, the user removes the battery from the first power tool and installs an electrical adaptor 230 onto either the contacts 214A, 214B, 214C, 214D of the battery or the contacts of the power tool, effectively extending the length of the contacts 214A, 214B, 214C, 214D. Then, the user couples the mechanical connectors together which indirectly but electrically engages the contacts of the power tool to the contacts of the battery through the adaptor. The battery provides power to the power tool via the electrical adaptor.

In a third embodiment as shown in FIG. 3, an adaptor 310 is implemented between the battery 314 and the power tool. The adaptor 310 may couple directly to the power tool or directly to the battery 314 and includes a housing 318 with mechanical connectors 322, electrical connectors, or both. In an embodiment where the adaptor 310 mounts to the battery 314, the adaptor 310 includes battery engagement features 326 such as permanent (e.g., plastic snap engagement feature), threaded fasteners (e.g., screws), or quick-release fasteners for mechanically engaging the battery housing 330. Additionally, the adaptor 310 includes mechanical connectors 322 that selectively engage and disengage the power tool. In some embodiments, an intermediary electrical connector is provided in the adaptor 310 that electrically couples to the battery 314 and electrically couples to the power tool when mechanically engaged therewith. In other embodiments, the adaptor 310 includes a passthrough 334 (e.g., an opening, a cutout, a relief) that allows the contacts 338 of the battery 314 to directly couple to the contacts of the power tool, even with the adaptor 310 mechanically positioned therebetween.

In an embodiment where the adaptor 310 mounts to the power tool, the adaptor 310 includes engagement features 322 for permanently or temporarily mechanically engaging the housing of the power tool. The adaptor 310 additionally includes mechanical connectors 326 that selectively engage and disengage the battery 314. An intermediary electrical connector or passthrough 334 (e.g., an opening, a cutout, a relief) is provided in the adaptor 310 as described above to provide electrical contact between the power tool and the battery 314.

The adaptor 310 according to the third embodiment provides a greater number of power tools that are engageable with the battery 314 as described. A first plurality of power tools may be engageable with the battery 314 without the adaptor 310 while a second plurality of power tools are not capable of electrically or mechanically connecting to the battery 314 without the adaptor 310. By providing the adaptor 310, the user is able to connect to any power tool from the first and second pluralities of power tools by either using or removing the adaptor 310.

In a fourth embodiment, the adaptor 410 positioned (mechanically and/or electrically) between the battery 420 and the power tool 430 incorporates the battery management system (BMS) 414 therein. The battery management system 414 monitors the status (state of balance, voltage, temperature, current, etc.) of the battery 420 and is often incorporated into the housing of the battery 420. By instead incorporating the battery management system 414 into the adaptor 410, the overall size of the battery housing can be reduced, and the manufacturing cost of each battery 420 can be reduced. The battery 420 itself would still retain a central processing unit 424 and/or arrangement of resistors for purposes of battery identification.

With a separated BMS 414, the battery 420 communicates electrically with the adaptor 410 to relay battery status information. The electrical connection between the battery 420 and the adaptor 410 can likewise be used to transmit power from the battery 420, through the adaptor 410, and to the power tool 430. Alternatively, the adaptor 410 can incorporate an alternative electrical connector to function as an intermediary between the contacts of the battery 420 and the contacts of the power tool 430. As a still further alternative, the electrical connection for providing power from the battery 429 to the power tool 430 can be independent of the adaptor 410, bypassing the adaptor 410 entirely.

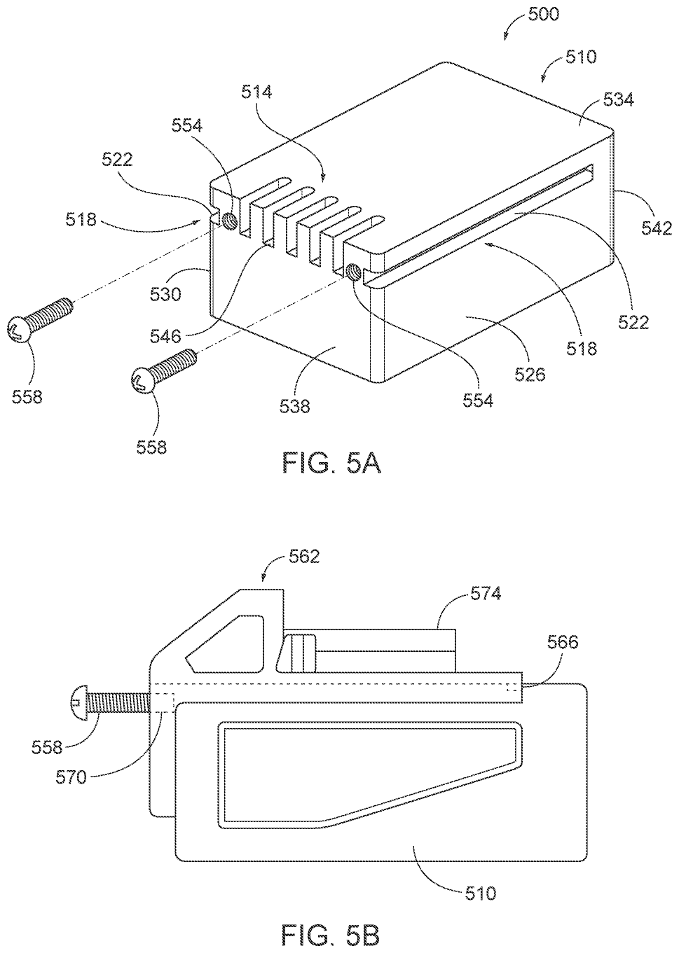

In a fifth embodiment, as shown in FIGS. 5A-5B, a battery 500 having a housing 510 is provided with an electrical connector 514 and a mechanical connector 518 that are configured to engage no power tools directly. The battery housing 510 includes rails 522 on opposing first and second sidewalls 526, 530 adjacent to a top surface 534. The rails 522 run substantially the entire length (e.g., 80% or greater, 90% or greater) of the first and second sidewall 526, 530, starting at a third sidewall 538 and terminating just prior to a fourth sidewall 542, opposite the third sidewall 538. The top surface 534 and the third sidewall 538 additionally include slots 546 formed at an edge defined therebetween with electrical contacts 550 located within the slots 546. The third sidewall 538 also includes a plurality (e.g., two) of threaded openings 554 for receiving threaded fasteners 558.

While the battery housing 510 shown in FIG. 5A is not configured to directly engage a power tool, a replaceable adaptor 562, as shown in FIG. 5B, engages the housing 510 as an adaptor between the battery housing 510 and the power tool. As shown, the adaptor 562 includes inwardly facing protrusions 566 that slide within the rails 522 of the battery housing 510 to mechanically align the adaptor 562 on the battery housing 510. Once slid into position, electrical contacts within the adaptor 562 engage the contacts 550 positioned within the slots 546 of the battery housing 510. Threaded fasteners 558 are inserted through openings 570 (threaded or unthreaded) in the adaptor and into the threaded openings 554 (FIG. 5A) of the battery housing 510 to mechanically lock the adaptor 562 into place. The adaptor 562 includes mechanical and electrical connectors 574 sized to mate with the power tool.

The battery 500 shown in FIG. 5A is not only capable of electrically and mechanically connecting to the power tool as described above but can connect to a different power tool having a different electrical and/or mechanical connector by replacing the adaptor 562 with a different adaptor associated with the different power tool. As such, by replacing the adaptor 562, the battery 500 is capable of electrically and mechanically connecting (and providing power) to different power tools of different brands and/or with different interfaces.

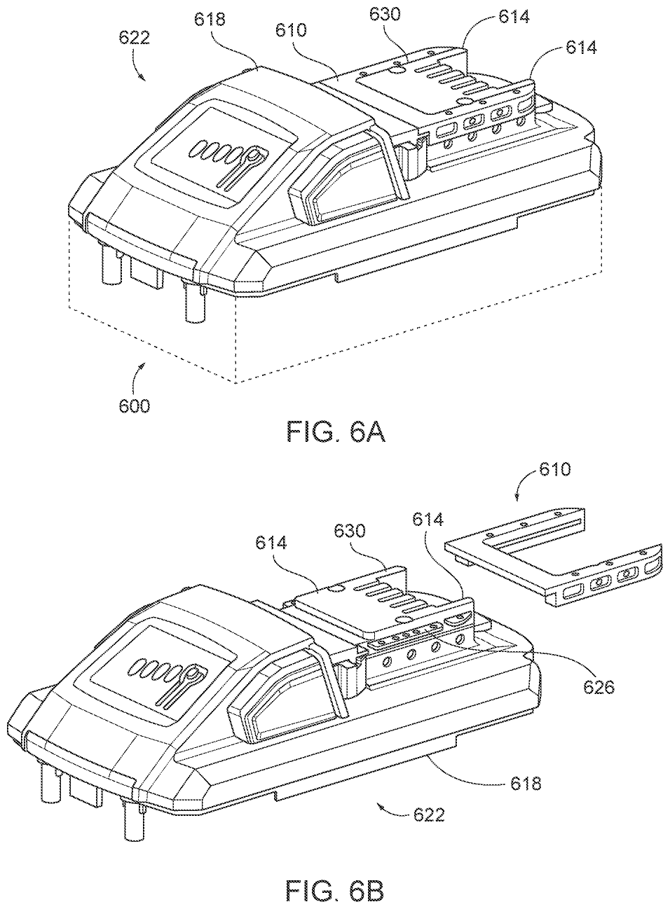

In a sixth embodiment, as shown in FIGS. 6A-6B, a rail adaptor 610 is provided for engagement with a mechanical connector 614 located on the upper housing portion 618 of the housing 622 of the battery 600. In some embodiments, with the rail adaptor 610 removed, the battery 600 is unable to mechanically engage with a power tool such that the rail adaptor 610 is necessary for mechanically engaging the power tool. In other embodiments, the mechanical connector 614 on the upper housing portion 618 is configured to mechanically engage a first plurality of power tools while the adaptor 610 permits engagement with a second plurality of power tools. In some embodiments, multiple different rail adaptors 610 having different dimensions and proportions can be coupled to the battery housing 622 to provide different mechanical connectors for engaging various power tools.

The rail adaptor 610 is a plastic rail adaptor and may be made from a similar material as the remainder of the upper housing portion 618 of the battery 600. As shown, the rail adaptor 610 slides over the metal insert 626 of the terminal block 630. In some embodiments, a retention feature (e.g., detent) holds the rail adaptor 610 in place. A release mechanism may disengage the retention feature to permit removal. Alternatively, a user may physically overcome the retention feature to remove the rail adaptor 610 from the terminal block 630. By introducing the rail adaptor 610 as a separate part (i.e., separate from the remainder of the battery), differently sized rail adaptors 610 may be incorporated to mechanically couple the battery 600 to different power tools having different mechanical connectors. Additionally, the rail adaptor 610 can be replaced if it becomes worn down without replacing the entirety of the upper housing portion 618 of the battery housing 622.

In some embodiments, the battery housing 622 is provided with a rail (e.g., formed with the remainder of the terminal block) and the rail adaptor 610 is sized to fit over the existing, integral rail, thereby increasing the size of the rail. In this way, the rail engages the mechanical connectors of some power tools while the rail adaptor 610 engages the differently sized mechanical connectors of other power tools.

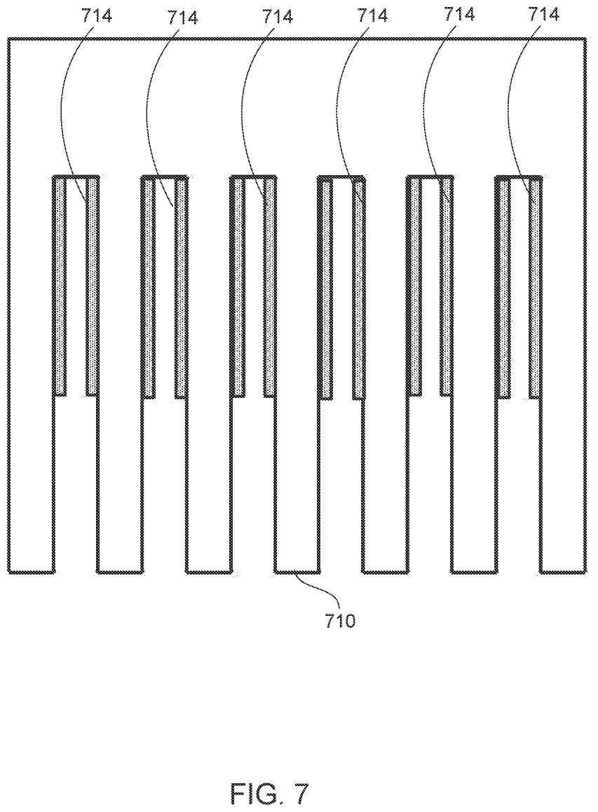

In a seventh embodiment as shown in FIG. 7, the battery includes a terminal block 710 having a plurality of different terminals 714 (i.e., contacts) for electrically contacting mating terminals (i.e., contacts) of a power tool. In this embodiment, the terminals 714 utilized by the battery may differ from those used by a different battery, even when electrically connecting to the same power tool. In some embodiments, the battery of the embodiment (i.e., first battery) has a pouch form factor, whereas the different battery (e.g., second battery) has a cylindrical form factor. In some embodiments, none of the terminals 714 used to electrically couple the first battery to the power tool are used to electrically couple the second battery to the power tool. In some embodiments, none of the terminals 714 used to electrically couple the second battery to the power tool are used to electrically couple the first battery to the power tool. In other embodiments, one or two of the terminals 714, but not all of the terminals 714, are utilized in electrically connecting both of the first and second batteries.

The first battery may utilize a dedicated terminal 714 for identifying the battery (e.g., identifying the form factor of the battery) that is not utilized by the second battery. The power tool may be limited (e.g., power draw, speed, power output) based on the form factor of the battery attached thereto and this information can be communicated between the battery and the power tool via one or more terminals 714 otherwise unused by the different battery.

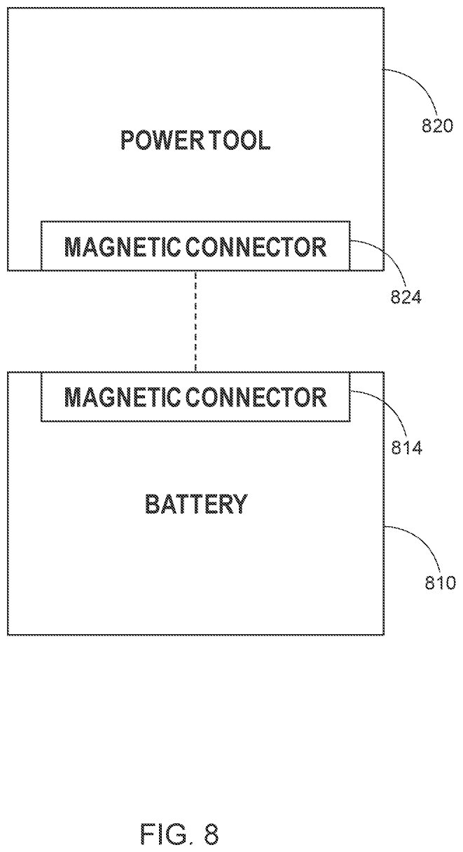

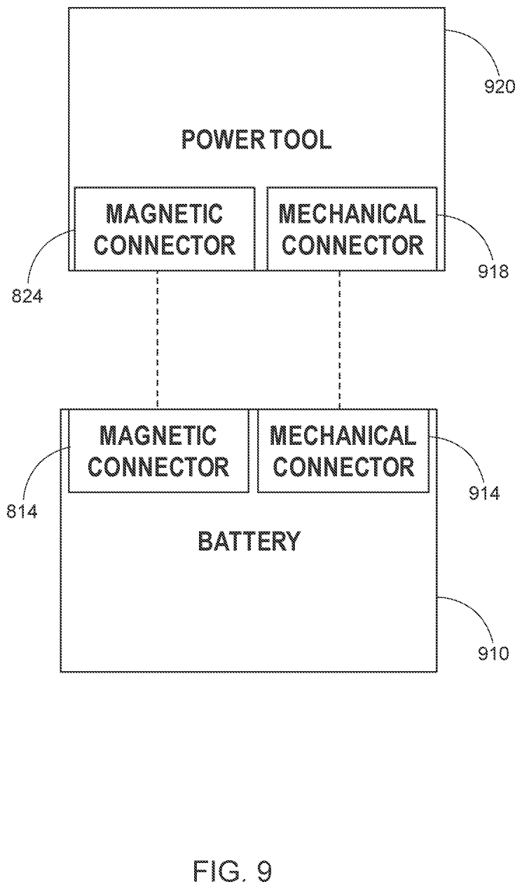

In an eighth embodiment as shown in FIG. 8, magnets 814, 824, such as rare earth magnets (e.g., neodymium magnets) may be utilized as both the mechanical and electrical connectors for connecting the battery 810 to the power tool 820. The magnets 814, 824 may be coated in an electrically conductive material such as nickel or copper to facilitate the electrical connection between the battery 810 and the power tool 820. The power tool 820 is provided with a magnet 824 (or other magnetic material) for electrically and mechanically connecting to the battery 810. In some embodiments, the magnetic connection is the primary (and only) means for mechanically and electrically connecting the battery 810 to the power tool 820. In other embodiments, as shown in FIG. 9, a further mechanical connector 914, 918 is provided (in addition to the magnetic connector 814, 824) at the battery 910 and power tool 920 as a back-up to prevent accidental separation or as a locking latching mechanism.

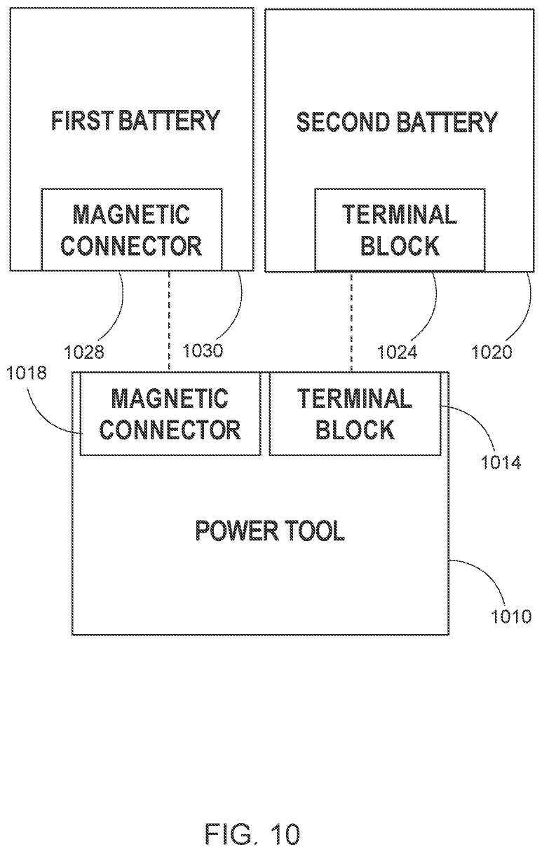

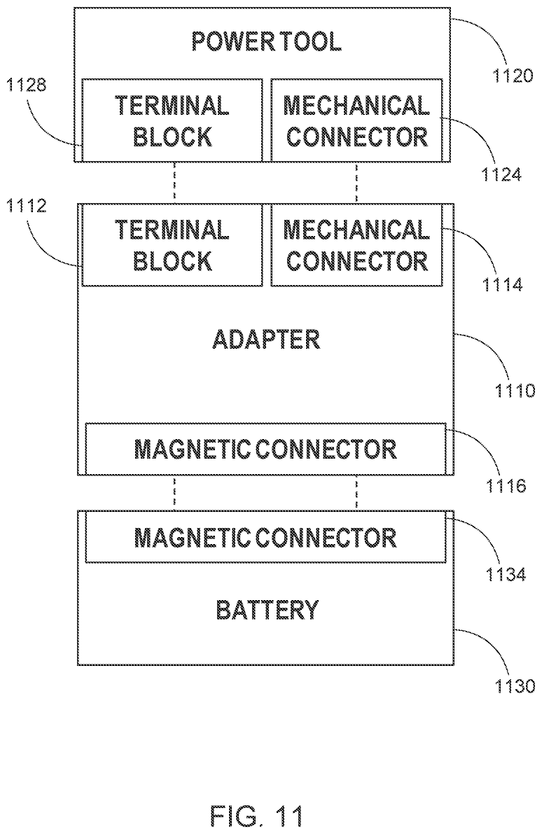

In still other embodiments as shown in FIG. 10, in addition to the magnetic connector 1018, a standard terminal block 1014 is provided at the power tool 1010 for engaging batteries 1020 that do not include a magnetic connector (such as the magnetic connector 814 of the batteries 810, 910 described with respect to FIGS. 8-9). With this arrangement, the power tool 1010 is configured to connect to batteries 1020, 1030 using either a connection of terminal blocks 1014, 1024 or the magnetic connector 1018, 1028. In still further embodiments as shown in FIG. 11, an adaptor 1110 may incorporate a terminal block 1112 and mechanical connector 1114 for engaging a power tool 1120 and a magnetic connector 1116 for engaging the battery 1130, with the terminal block 1112 and magnetic connector 1116 electrically connected to one another. The adaptor 1110 converts the mechanical and electrical connections 1124, 1128 of the power tool 1120 into connectors that engage the magnetic connector 1134 of the battery.

Except where contradictory, any of the embodiments described above and shown in the figures can be used in combination with one another to create a mechanical and/or electrical connection between a battery pack and a plurality of different power tools having different mechanical and/or electrical connections such that the battery pack is configured to separately mechanically engage each power tool while simultaneously providing power to the respective power tool.

What is claimed is:

1. A power tool system comprising:
a first power tool having a mechanical connector and an electrical connector;
a second power tool having a mechanical connector and an electrical connector, wherein at least one of the mechanical or the electrical connector of the second power tool is dissimilar from the mechanical or the electrical connector of the first power tool;
a battery housing defining a cavity therein, the battery housing at least partially defined by an upper housing portion;
a battery cell positioned within the cavity of the battery housing;
a mechanical connector physically coupled to the upper housing portion and configured to mechanically couple with the mechanical connector of the first power tool;
an electrical connector electrically coupled to the battery cell and configured to electrically couple with the electrical connector of the first power tool; and
an adaptor configured to removably engage the mechanical connector of the battery and/or the electrical connector of the battery such that the battery is configured to mechanically and electrically couple to the second power tool when the adaptor is coupled to the battery and is configured to mechanically and electrically couple to the first power tool when the adaptor is removed from the battery.

2. The power tool system of claim 1, wherein the adaptor is a terminal block removable from the battery housing.

3. The power tool system of claim 1, wherein the adaptor includes a mechanical connector configured to engage the mechanical connector of the second power tool.

4. The power tool system of claim 1, wherein the adaptor includes a passthrough such that the electrical connector of the battery is configured to directly engage the second power tool when the adaptor is mechanically coupled to the battery.

5. The power tool system of claim 1, wherein the adaptor includes a removable rail configured to mechanically engage a terminal block of the battery.

6. The power tool system of claim 1, wherein the adaptor is configured to removably engage the mechanical connector of the battery and the electrical connector of the battery such that the battery is configured to mechanically and electrically couple to the second power tool.

7. The power tool system of claim 1, wherein the adaptor includes a battery management system configured to monitor a status of the battery, the status of the battery comprising at least one of a state of balance of the battery, a voltage of the battery, a temperature of the battery, or a current of the battery.

8. The power tool system of claim 7, wherein the battery includes a central processing unit separate from the battery management system, the central processing unit configured to provide a battery identification.

9. The power tool system of claim 1, wherein the electrical connector of the battery is precluded from directly electrically coupling to the electrical connector of the second power tool.

10. The power tool system of claim 9, wherein the adaptor is electrically coupled to the electrical connector of the battery and is electrically coupled to the electrical connector of the second power tool to provide an electrical connection therebetween.

11. The power tool system of claim 1, wherein the adaptor includes a magnetic connector configured to engage one or both of the mechanical connector and the electrical connector of the battery such that the battery is configured to mechanically and electrically couple to the second power tool when the adaptor is coupled to the battery.

12. The power tool system of claim 1, wherein the battery housing includes a recess sized to receive the adaptor.

13. The power tool system of claim 1, wherein the adaptor is a first adaptor having a first electrical connection, wherein the battery housing includes a recess sized to separately receive the first adaptor and a second adaptor having a second electrical connection different than the first electrical connection.

14. The power tool system of claim 1, wherein the adaptor configured to only engage the mechanical connector of the battery.

15. The power tool system of claim 1, wherein the adaptor is coupled to the battery via a threaded fastener.

16. A power tool system comprising:
a power tool having a mechanical connector and an electrical connector;
a battery housing defining a cavity therein, the battery housing at least partially defined by an upper housing portion;
a battery cell positioned within the cavity of the battery housing;
a mechanical connector physically coupled to the upper housing portion and configured to mechanically couple with the mechanical connector of the power tool; and
an electrical connector electrically coupled to the battery cell and configured to electrically couple with the electrical connector of the power tool;
wherein each of the electrical connector of the battery cell and the electrical connector of the power tool is a magnetic connector such that the electrical connector of the battery cell and the electrical connector of the power tool form a magnetic connection.

17. The power tool system of claim 16, wherein the mechanical connector of the power tool and the mechanical connector of the battery are separate from the electrical connector of the power tool and the electrical connector of the battery, respectively.

18. The power tool system of claim 17, wherein the power tool is electrically and mechanically coupled to the battery via the magnetic connection, and wherein the mechanical connector of the battery and the mechanical connector of the power tool further secure the battery to the power tool.

19. A power tool system comprising:
a first power tool having an electrical connector formed as a magnetic connector;
a second power tool having an electrical connector formed as a terminal block;
a battery housing defining a cavity therein, the battery housing at least partially defined by an upper housing portion;
a battery cell positioned within the cavity of the battery housing;
a first electrical connector physically coupled to the upper housing portion and formed as a magnetic connector configured to electrically couple the first power tool with the battery cell, and
a second electrical connector physically coupled to the upper housing portion and formed as a terminal block configured to electrically couple the second power tool with the battery cell.

20. The power tool system of claim 19, wherein the battery cell further comprises a mechanical connector configured to engage the first power tool and/or the second power tool.
